(19) United States
(12) Patent Application Publication
(10) Pub. No.: US 2013/0254044 A1
(43) Pub. Date: Sep. 26, 2013

(54) SELF-CHECKOUT GUIDANCE SYSTEMS AND METHODS

(71) Applicant: Peter Terry Catoe, Blowing Rock, NC (US)

(72) Inventor: Peter Terry Catoe, Blowing Rock, NC (US)

(21) Appl. No.: 13/385,605

(22) Filed: Jan. 13, 2012

(51) Int. Cl. G06Q 20/20

(52) U.S. Cl. CPC G06Q 20/20
USPC 705/16

(57) ABSTRACT

Improved self-checkout guidance systems and methods are shown and described.

### FIELD OF TECHNOLOGY

The present invention relates generally to systems and methods for automated self-checkouts, and more particularly to unattended self-checkout systems and methods including checkout guidance features.

### BACKGROUND

In a retail type environment, the efficiency with which consumers are able to process, pay for and purchase their desired items factors into the expenses for a retail type establishment. The labor hours attributable to manning checkout counters contributes greatly to this expense. In a typical retail operation, a shopper gathers the items desired for purchase and presents them at a checkout counter, a clerk then scans or enters the items' barcodes and the point-of-sale (POS) system totals the shopper's bill. The clerk may apply any promotional discounts to the bill, the shopper tenders payment and the items may be bagged for the customer. A number of self-service automated checkout terminal concepts have been developed in an attempt to reduce the need for a check-out clerk, thus reducing associated labor costs.

Toward reducing operating expenses, some businesses have implemented self-checkout counters that substitute for individual clerks and baggers at each checkout terminal. Self-checkout terminals are systems which are operated mainly by a customer without the direct aid of a checkout clerk. In such a system, the customer scans, selects or enters individual items for purchase, for example, across a scanner or screen and then places the selected items into a grocery type bag, if desired. The customer then pays for his or her purchase either at the self-service checkout terminal or at a central payment area. Thus, a self-service checkout terminal permits a customer to select, itemize and even pay for his or her purchases without the direct assistance of the retailer's personnel at each individual checkout terminal.

A customer typically has little or no training in the operation of a self-service checkout terminal and customers may make errors when checking out their items. Consumers can become confused by the various steps needed to complete a successful transaction. Compounding this confusion is the pressure a customer feels to move quickly at a self-checkout, often causing them to skip steps and miss verbal checkout directions. Further, self-checkouts equipped only with voice prompts fails to serve the hearing impaired community.

Thus, one concern that retailers have when evaluating a self-service checkout terminal is balancing the level of assistance to be provided to inexperienced customers and the amount of supervision required for automated checkout systems. If using the self-checkout terminal is difficult and results in user error then consumers are discouraged from repeated use, and throughput a main advantage of self-checkout terminals, may be greatly hindered.

Some attempts have been made to assist customers during self-checkout by voice prompts and visual aids, however, Applicant believes such attempts thus far have served to further complicate and confuse consumers. For example, proximity sensors have been used at checkout stations to trigger an associated visual guidance response; however, consumers not familiar with self-checkout systems may not approach and stand in the correct position to activate the correct proximity sensor and the consumer may become more confused when misdirected by misleading proximity triggered visual cues.

Therefore, there remains a need for an improved self-checkout guidance system and method that simplifies the checkout process and minimizes error in directing consumers through the process.

### SUMMARY OF THE INVENTION

The present invention is directed to one or more of these needs in the art. Accordingly, one example of an automated self-checkout system includes a self-checkout housing; a controller adapted to process a transaction conducted at the self-checkout; and a visual guidance device located on the self-checkout housing. The visual guidance device may be adapted to accept instructions from the controller and to direct the checkout transaction through a series of visual cues.

Another example presented in the disclosure includes a method for directing a self-checkout transaction comprising the steps of: presenting a consumer with a ready screen on a display attached to a self-checkout system; lighting a set of illuminated areas to indicate a ready state while the ready screen is presented; directing a consumer visually through a self-checkout transaction by intermittently lighting one or more illuminated area in order to indicate where the next part of the transaction is to occur, each area associated with a module contained on the self-checkout system; and returning to the welcome screen on the display once the transaction is complete.

These and other aspects of the exemplary invention will become apparent to those skilled in the art after a reading of the following description of the exemplary embodiment when considered with the drawings.

### BRIEF DESCRIPTION OF THE FIGURES

FIG. 1 is a front perspective view of an improved self-checkout guidance system constructed according to one embodiment of the disclosure;

FIG. 2 is an enlarged view of the top portion of the system as seen in FIG. 1.

FIG. 3 is an enlarged back perspective view of the top portion of the system as seen in FIG. 1.

FIG. 4 is a side perspective view of the top of an improved self-checkout guidance system constructed according to one embodiment of the disclosure;

FIG. 5 is an enlarged side view of the bottom of an improved self-checkout guidance system constructed according to one embodiment of the disclosure;

FIG. 6a-g shows views of an improved self-checkout guidance system according to one embodiment of the disclosure with various modules illuminated.

FIG. 7 is a flow chart of an exemplary transaction using the visual guidance device of one embodiment of the automated self-checkout disclosed.

### DESCRIPTION OF THE EXEMPLARY EMBODIMENTS

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

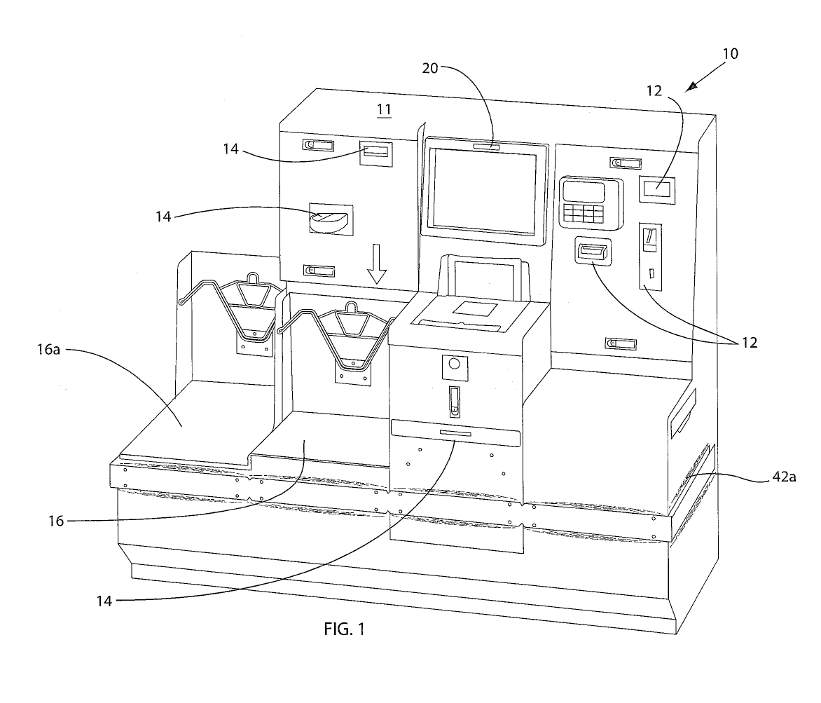

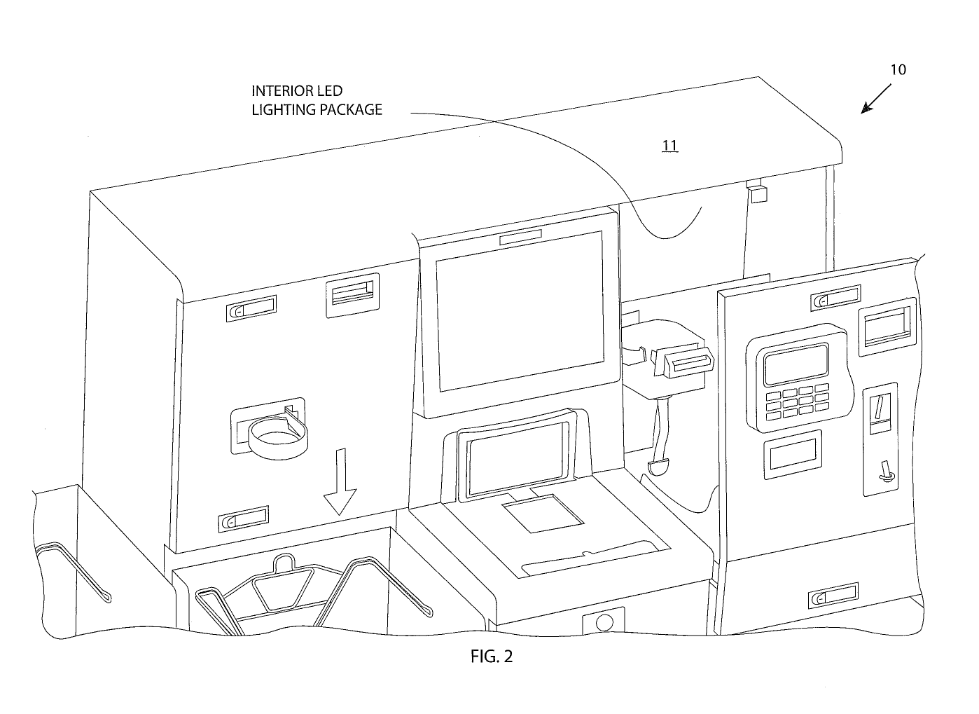

Referring now to the figures in general and FIG. 1 in particular, it will be understood that the illustrations are for the purpose of describing an exemplary embodiment of the invention and are not intended to limit the invention thereto. As best seen in FIG. 1, generally designated 10, one example of an automated self-checkout system is shown. The system may vary from example to example, but the system may often include a housing 11, typically of compact design, which accommodates or houses the other aspects of the self-checkout system. The housing 11 may be a pre-existing structure at the installation site of the self-checkout system, may resemble the housing as shown in FIG. 1, or may take on other shapes able to accommodate the other aspects of the invention.

The system 10 may also include input modules 12, output modules 14 and transaction modules 16. The input module 12, as seen in FIG. 1 may be, for example, a coupon-in center, credit/debit card reader, or a payment center. The input module 12 may typically be supported on, integral to, or attached to the housing 11. Input module 12 is arranged to accept input about or for the transaction, for example, from items being purchased by recognizing the item, such as through selection on the display 20 by the customer or by recognition of an identification or code. A bar code scanner would be another example of an input module 12 suitably found in system 10. Other examples, inter alia, may include one or more keypads to key in information, RFID reader, a microphone with voice recognition software, a touch screen keypad, a video camera, tablet computer, wireless communication receiver, a credit card reader, a debit card reader, a smart card reader, a cash receiver a wireless transmission, a mobile phone, and/or any of these in combination.

Output module 14, as seen in FIG. 1, may include a coin-out center, a cash-out center and/or a receipt center. Output module 14 is arranged to provide and receive information during a transaction. Output module 14 may provide instructions to the purchaser or provide feedback from input received through Input module 12. For example, the identification and recorded price of scanned items may be displayed to the customer on display 20. In the case of a touch screen display, purchasers may also input information making the display serve as both a part of the input module 12 and output module 14. A speaker (not shown) may also serve to provide information to consumers. Other examples of output module 14 may include a private printing page, a link transmitting to a handheld device such as a mobile phone or tablet computer or the like.

Transaction module 16 includes centers accommodated by housing 11 where parts of the transaction occur, such as the bagger 16 and auxiliary bagger 16a. Transaction module 16 may also include, by way of example, weigh centers, bumper guards or transaction shelving centers.

The system 10 further includes, a controller (not shown), operatively connected to the input module 12 and output module 14. The controller has programming arranged to process information from the input module 12, such as the items being purchased in the transaction, and to provide information through output module 14 to the customer to allow completion of a customer transaction through system 10.

The controller includes an associated memory. The controller includes input/output ports in order to receive information from and to provide information to the modules included in the system 10. By way of example, the controller receives information from the input module 12 and provides data to the output module 14. The controller typically has a clock component so that elapsed time between events can be determined. Other configurations of times can be used. The programming of the controller will make use of such determinations of elapsed time between events and compare the determined amounts of time with certain thresholds to sequence through a transaction.

A communication interface is provided so that the controller can transmit and receive information to and from another server. The controller may be able to assess whether or not a communication link is disconnected at any point in time. In one embodiment, when a communication link is disconnected, the controller may be able to direct a purchaser transaction and store in memory the transaction until at least the time when communication link is restored.

The computer system may include a main memory or a secondary memory, or both, that may communicate with the controller. The main memory is generally a random access memory (RAM) that may include an item buffer for temporarily holding identification information corresponding to scanned items before the items are verified by the self-checkout system 10. On the other hand, the secondary memory with standard input/output ports may include any storage medium such as but not limited to a hard disk drive, a SCSI drive, a removable storage drive or removable storage units and interface. Alternatively, the secondary memory may include handheld computing devices, as well as, one or more databases such as a look-up database that includes SKU number, price, item codes, tolerance range for the item or for a class of items, and corresponding weight, height, length, or width for each item in the store. This database may reside on one or more of different or additional computers such as at a central store server or a remote server outside of the location.

Additionally, it is contemplated that the checkout system 10 may not include a main memory. In this situation, the controller may communicate with the secondary memory which may be a remote server, for example, accessed via local area network or global networking such as the Internet or Intranet, and refresh a display screen with information and software stored in the remote server.

The system 10 further includes a visual guidance device. The visual guidance device is adapted to accept instructions from the controller and to direct the checkout transaction through a series of visual cues. The visual guidance device includes intermittently illuminated areas at the input and output modules adapted to be illuminated as a part of the series of visual cues. Applicant's visual guidance device is designed to guide the consumer through the transaction and not to be responsive to the consumers' direction. For example, if a visual guidance system relies on input stimulated by the consumer, such as proximity sensors, then Applicant realizes that the visual guidance system is subject to errant direction if the consumer improperly approaches the checkout. Instead, Applicant's system continually directs the consumer to the correct step by visually reinforcing the next action, irrespective of errors by the user.

As seen in FIG. 2, the housing 11 may be equipped with an interior lighted package, in one embodiment LED (light emitting diodes) type lighting. By way of example, LED lighting may provide the lighting to the illuminated areas and intermittently used to draw the consumers visual attention to the items of current concern. Each LED may emit through a gap between opaque materials providing a softer, muted look to the lighting. The opaque material may be flush with the housing surface to appear embedded in the housing 11. The LED may alternate between colors, for example green to indicated “go” at a particular area and/or red to indicated “stop” because there is a problem. The illuminated area may remain lit or may be directed to flash at varying speeds.

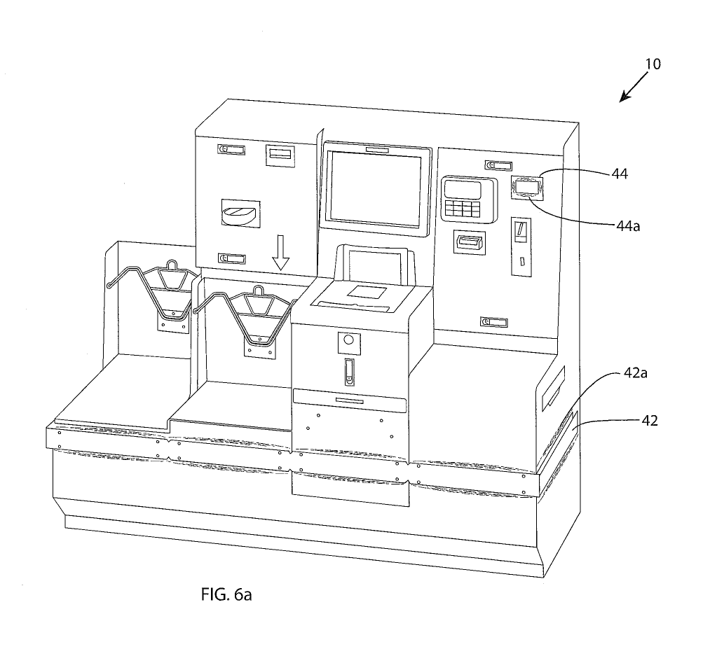

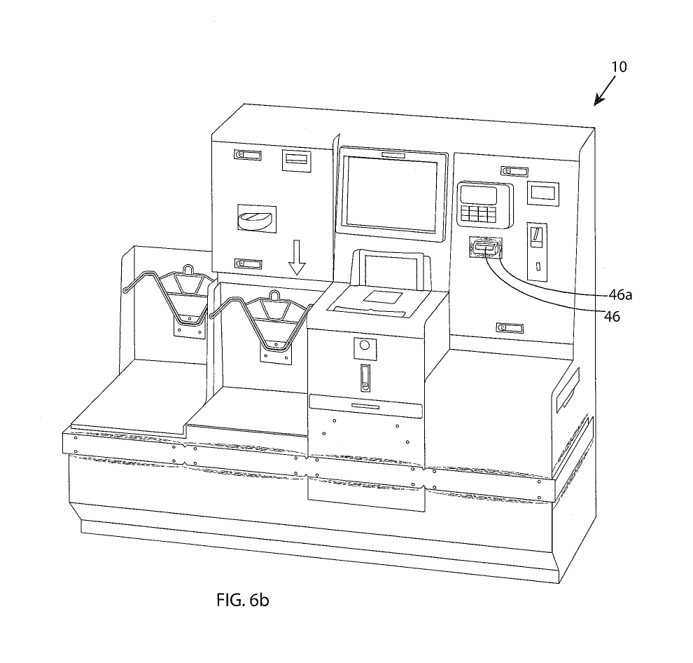

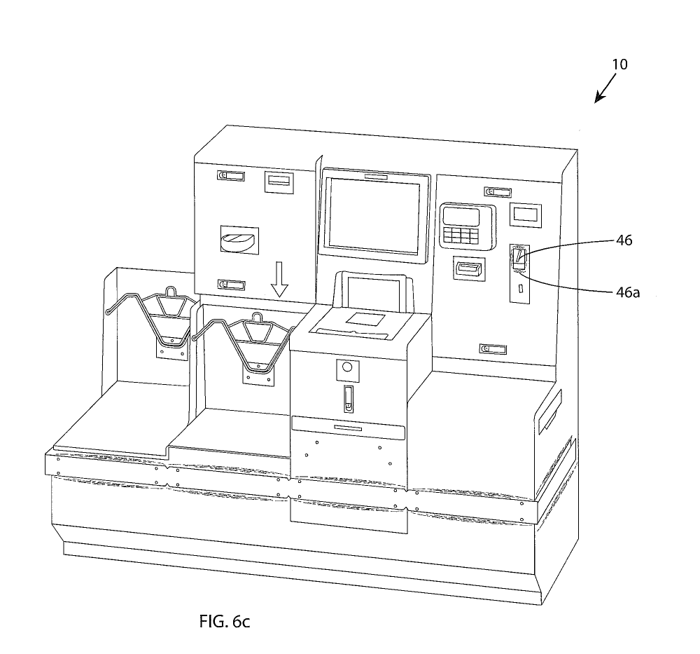

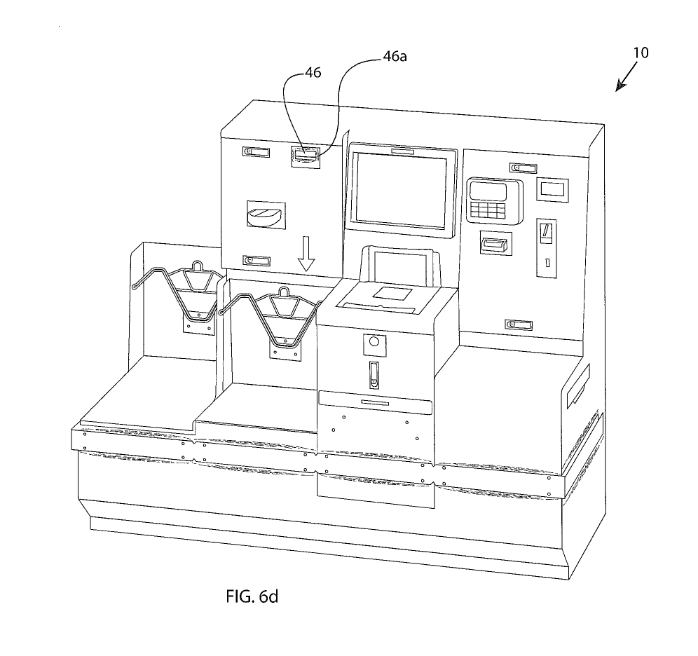

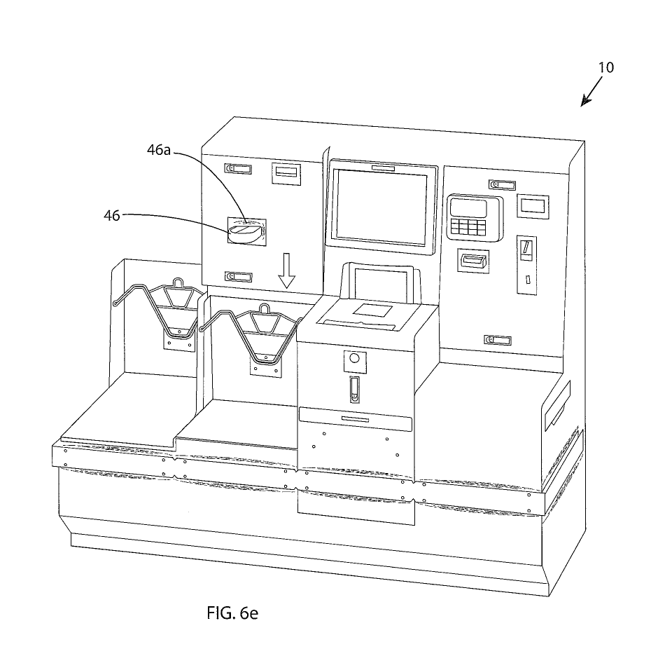

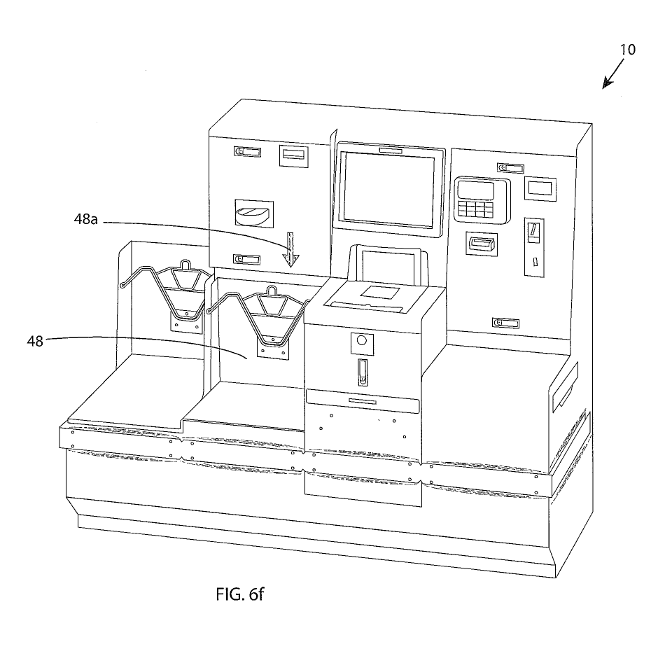

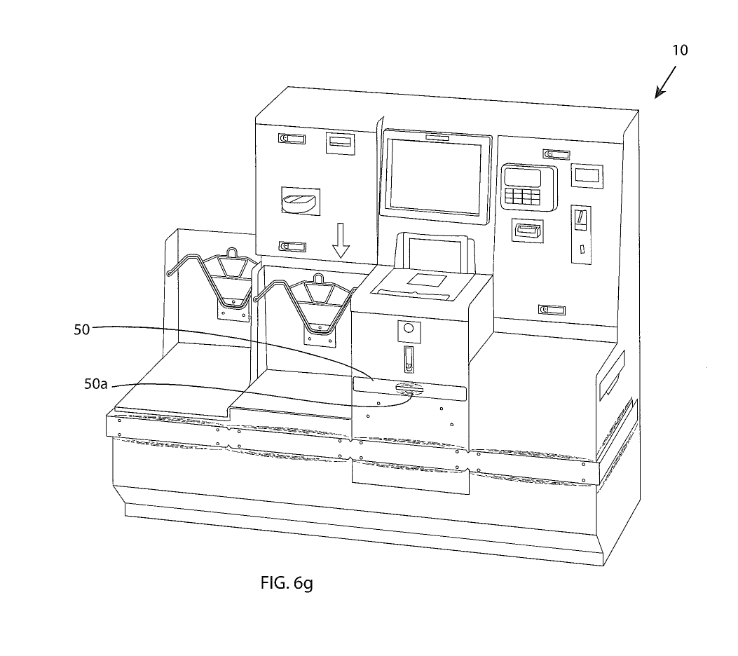

Typically, as seen in FIGS. 6a-g, the varying parts of the input and output modules 12, 14 and 16 may each have an illuminated area. In FIG. 6a the transaction module 16 includes a bumper guard 42 with an illuminated area 42a. Input Module 12 includes a coupon-in center 44 with an illuminated area 44a. FIGS. 6b and 6e shows payment centers 46 each with an illuminated area 46a. FIG. 6f shows an illuminated area 48a associated with a bagging center 48. FIG. 6g illustrates a receipt center 50 having an illuminated area 50a.

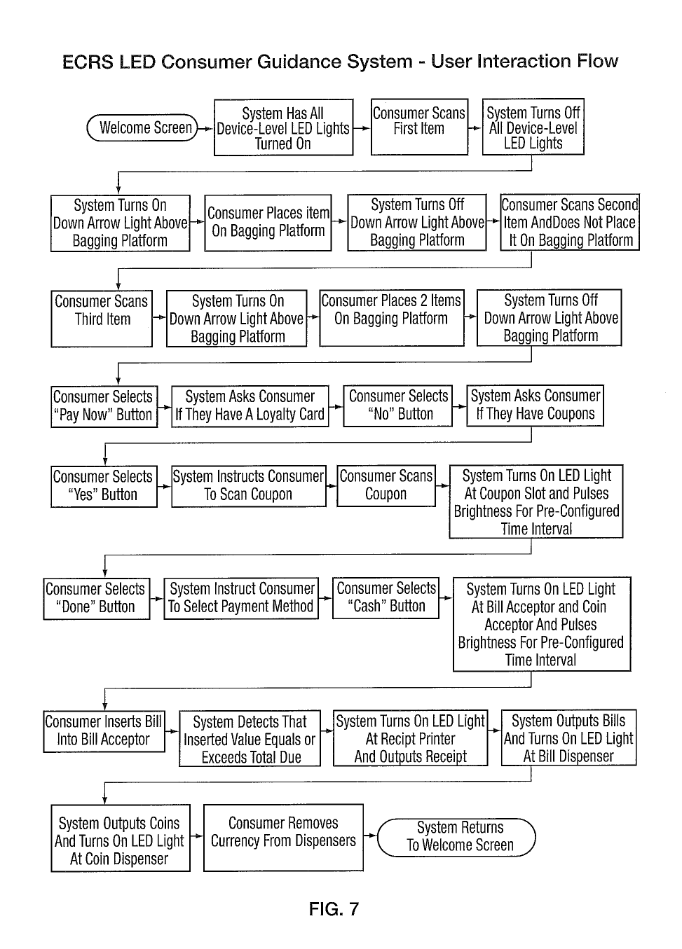

In operation, the various illuminated areas may be directed by the visual guidance system to guide a consumer through a transaction alone or may be coupled with verbal directions. An example of the visual guidance device in use during a consumer transaction may be seen in FIG. 7.

Typically, the system 10 will present a customer with a welcome screen on display 20 when the system is prepared to begin a transaction. When the welcome screen is presented, all of the illuminated areas may be lit with LED lighting turned on. When a consumer begins a transaction, for example, by scanning a first item, the controller signals the visual guidance device to turn off lighting to all or a portion of the illuminated areas. An illuminated area 48a may be activated to draw attention to the bagging center 48 in order to direct the consumer to place the scanned item into a bag. Once the bagging center, inputs information that indicates the scanned item has been placed into the bagging center the controller signals the visual guidance device to turn off illuminated area 48a. Scanning the desired items continues iteratively until the consumer elects to end scanning and to tender payment. The customer may be asked for loyalty cards or coupons and the illuminated areas at the scanner and/or the corresponding coupon-in center 44/44a may be activated to illuminate. Illumination at the illuminated areas may be configured by the controller and the visual guidance device to pre-configured time intervals for a solid or a variable flashing status. Once a consumer indicates they are done inputting coupon or discount information (by responding to a conventional prompt), the transaction moves into a payment mode and illuminated areas 46a at the payment center 46 may be activated. Once payment is tendered, any illuminated areas 46a are turned off and any amount owed the consumer is determined. Typically, an illuminated area at the receipt center will be activated and a receipt provided. Next, if money is owed the customer, the locations of the payment center 46, such as coins and bill dispensers, where change may be tendered are signaled to illuminate 46a. When the currency is removed from the payment center 46, the illuminated areas 46a are turned off, the transaction concludes and the system returns to the welcome screen and all illuminated areas lit mode.

Also disclosed is a method for directing a self-checkout transaction. In one embodiment, the method for directing a self-checkout transaction providing a self-checkout system with a housing, a controller adapted to process a transaction conducted at the self-checkout and a visual guidance device in communication with the controller. The method further includes adapting the visual guidance device to accept instructions from the controller and to direct the checkout transaction through a series of visual cues.

In another example, a method for directing a self-checkout transaction includes presenting a consumer with a ready screen on a display attached to a self-checkout system; lighting a set of illuminated areas to indicate a ready state while the ready screen is presented; directing a consumer visually through a self-checkout transaction by intermittently lighting one or more illuminated area in order to indicate where the next part of the transaction is to occur, each area associated with a module contained on the self-checkout system and triggered by a visual guidance device; and returning to the welcome screen on the display once the transaction is complete.

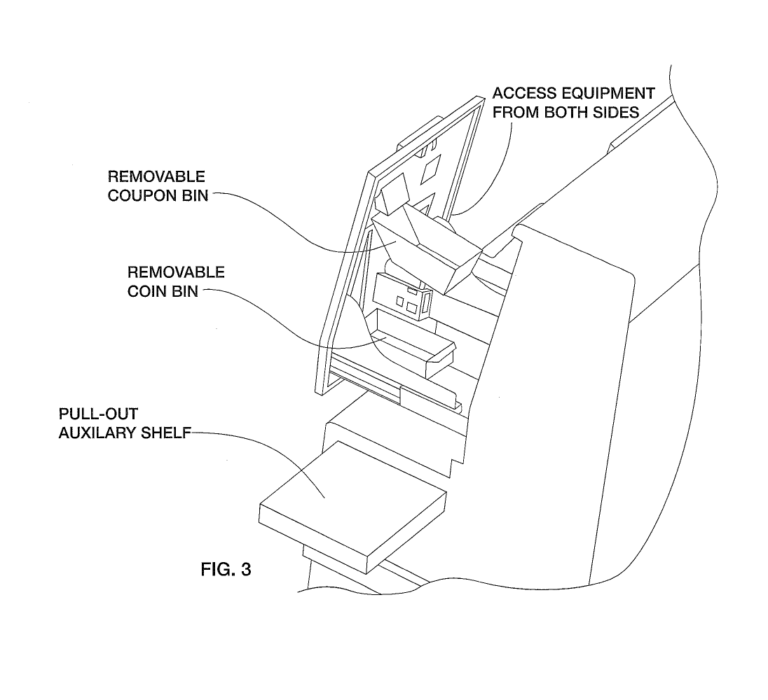

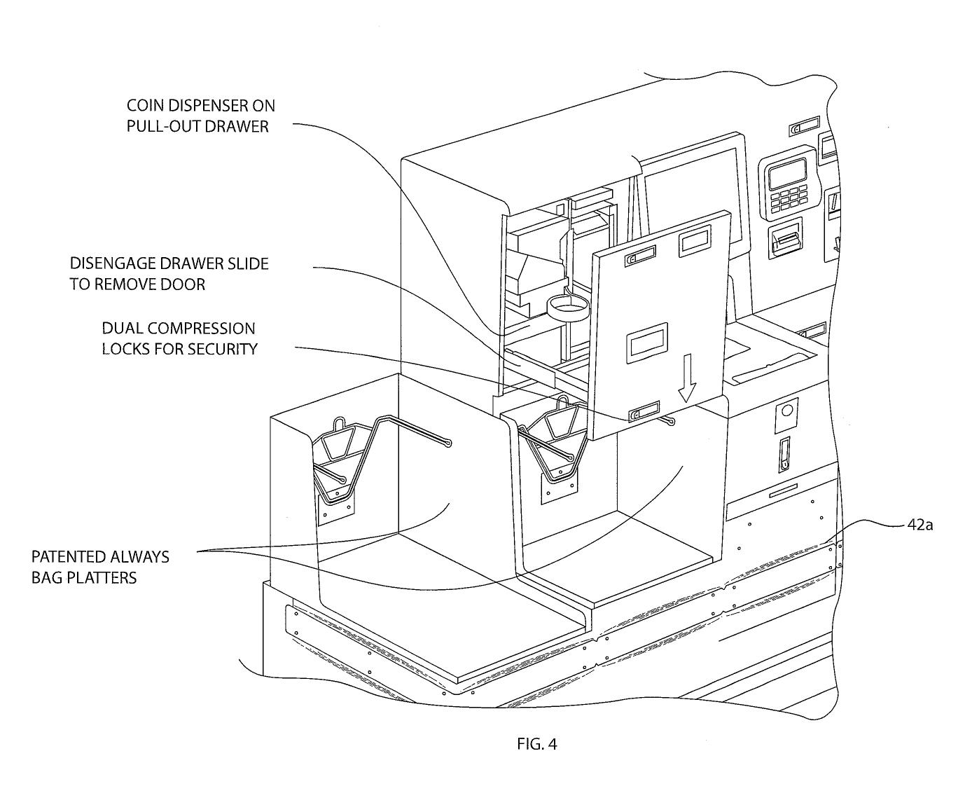

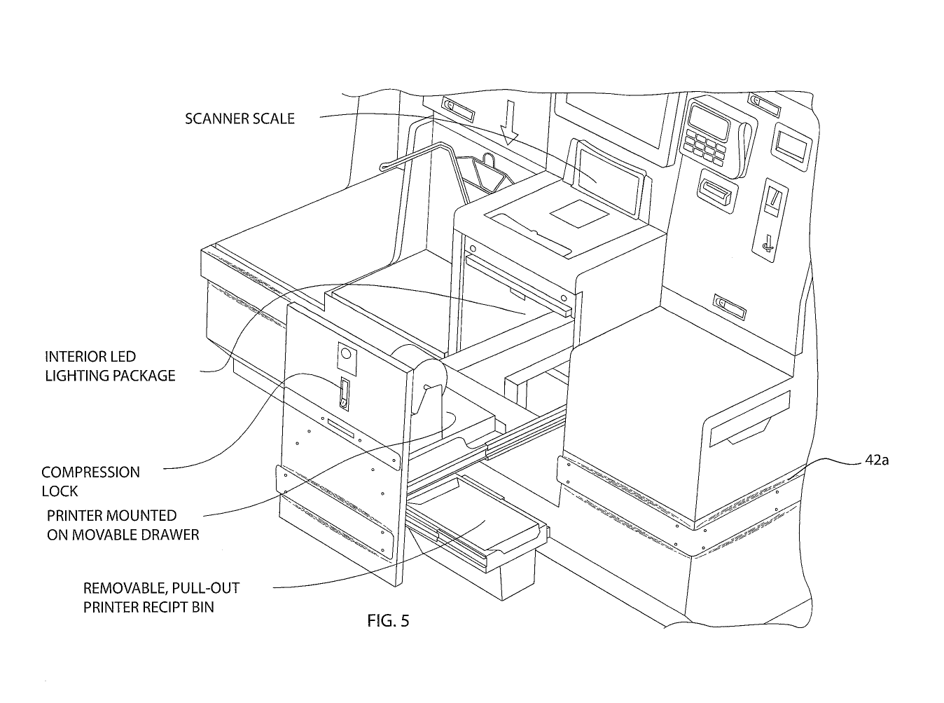

We have also invented and included in the disclosure a new, original and ornamental design for a SELF-CHECKOUT GUIDANCE SYSTEM, of which the following is a specification, reference being had to the accompanying drawings: FIGS. 6a-6g are perspective views of a SELF-CHECKOUT GUIDANCE SYSTEM showing our new design. FIG. 2 shows a close-up perspective view of the top portion of the SELF-CHECKOUT GUIDANCE SYSTEM of FIGS. 6a-6g. FIG. 3 shows a close-up back perspective view of the SELF-CHECKOUT GUIDANCE SYSTEM of FIGS. 6a-6g. FIG. 5 shows a close-up perspective view of the bottom portion of the SELF-CHECKOUT GUIDANCE SYSTEM of FIGS. 6a-6g.

### We Claim

The ornamental design for a SELF-CHECKOUT GUIDANCE SYSTEM, as shown and described with reference to FIGS. 2, 3, 5, 6a, 6b, 6e, 6d, 6e, 6f and 6g.

Certain modifications and improvements will occur to those skilled in the art upon a reading of the foregoing description. It should be understood that all such modifications and improvements have been deleted herein for the sake of conciseness and readability but are properly within the scope of the following claims.

1. An automated self-checkout system comprising:
a self-checkout housing;
a controller adapted to process a transaction conducted at the self-checkout; and
a visual guidance device in contact with the controller;
wherein the visual guidance device is adapted to accept instructions from the controller and to direct the checkout transaction through a series of visual cues.

2. The system according to claim 1, further including input modules, output modules and transaction modules.

3. The system according to claim 2, wherein the input module includes a payment center.

4. The system according to claim 3, further including a coupon center having an illuminated area.

5. The system according to claim 4, further including a center adapted to accommodate input information.

6. The system according to claim 2, wherein the output module includes a receipt center and a payment center each having an illuminated area.

7. The system according to claim 2 wherein the visual guidance device includes an intermittently illuminated area at the input and output modules adapted to illuminate as a part of the series of visual cues.

8. The system according to claim 2 wherein the transaction module includes a bagging center having an illuminated area.

9. A method for directing a self-checkout transaction comprising the steps of:
providing a self-checkout system with a housing, a controller adapted to process a transaction conducted at the self-checkout and a visual guidance device in communication with the controller; and
adapting the visual guidance device to accept instructions from the controller and to direct the checkout transaction through a series of visual cues.

10. The method of claim 9 further including providing the housing with input modules, output modules and transaction modules.

11. The method of claim 10 further including equipping the input and output modules with an intermittently illuminated area adapted to be illuminated by the visual guidance device as a part of the series of visual cues.

12. A method for directing a self-checkout transaction comprising the steps of:
presenting a consumer with a ready screen on a display attached to a self-checkout system;
lighting a set of illuminated areas to indicate a ready state while the ready screen is presented;
directing a consumer visually through a self-checkout transaction by intermittently lighting one or more illuminated area in order to indicate where the next part of the transaction is to occur, each area associated with a module contained on the self-checkout system and triggered by a visual guidance device; and
returning to the welcome screen on the display once the transaction is complete.
